(19) United States
(12) Patent Application Publication
(10) Pub. No.: US 2007/0172598 A1
(43) Pub. Date: Jul. 26, 2007

(54) Method and device for coating a metal bar by hot dipping

(76) Inventors: Rolf Brisberger, Spielberg (AT); Bernhard Tenckhoff, Duisburg (DE); Holger Behrens, Erkrath (DE); Hans Georg Hartung, Pulheim (DE)

Correspondence Address: FRIEDRICH KUEFFNER, 317 MADISON AVENUE, SUITE 910, NEW YORK, NY, 10017, US

(21) Appl. No.: 10/552,307

(22) PCT Filed: Mar. 18, 2004
(86) PCT No.: PCT/EP04/02786

§ 371 Date: Jun. 13, 2006

(30) Foreign Application Priority Data
Apr. 9, 2003 (DE) 10316137.6

(51) Int. Cl. B05D 1/18; B01J 19/08; B05C 3/12; B05C 3/00

(52) U.S. Cl. 427/430.1; 427/457; 118/420; 118/423

(57) ABSTRACT

The invention relates to a method for coating a metal bar (1), in particular a steel strap by hot dipping consisting in vertically passing the metal bar (1) through a container (2) containing a molten coating metal (3) and through a guiding channel (4) which is connected in series and has a predefined height (H). In order to retain the coating metal (2) in the container (3), an electromagnetic field is produced at the level of said guiding channel (4) by means of at least two inductors (5) which are arranged on two sides of the metal bar (1). In order to calm the coating bath, a predefined volume flow (Q) of the coating metal (2) is directed towards the guiding channel (4) at the level of the vertical extension (H) thereof. The inventive device for coating a metal bar by hot dipping is also disclosed.

The invention concerns a method for hot dip coating a metal strand, especially steel strip, in which the metal strand is passed vertically through a coating tank that holds the molten coating metal and through an upstream guide channel of well-defined height, wherein an electromagnetic field is generated in the region of the guide channel by means of at least two inductors installed on either side of the metal strand for the purpose of retaining the coating metal in the coating tank. The invention also concerns a device for hot dip coating a metal strand.

Conventional metal dip coating installations for metal strip have a high-maintenance part, namely, the coating tank and the fittings and fixtures it contains. Before being coated, the surfaces of the metal strip to be coated must be cleaned of oxide residues and activated to allow bonding with the coating metal. For this reason, before being coated, the strip surfaces are subjected to a heat treatment in a reducing atmosphere. Since the oxide coatings are first removed chemically or abrasively, the surfaces are activated by the reducing heat-treatment operation in such a way that they are present in pure metallic form after the heat-treatment operation.

However, the activation of the strip surface increases the affinity of the strip surface for the surrounding atmospheric oxygen. To protect the strip surfaces from being exposed to atmospheric oxygen again before the coating operation, the strip is introduced into the hot dip coating bath from above in a immersion snout. Since the coating metal is in a molten state, and one would like to utilize gravitation together with blowing devices to adjust the coating thickness, but the subsequent operations prohibit strip contact until complete solidification of the coating metal has occurred, the strip must be deflected in the vertical direction in the coating tank. This is accomplished with a roller that runs in the molten metal. This roller is subject to strong wear by the molten coating metal and is the cause of shutdowns and thus production losses.

Due to the desired low coating thicknesses of the coating metal, which are on the order of micrometers, strict requirements must be placed on the quality of the strip surface. This means that the surfaces of the rollers that guide the strip must also be of high quality. Defects in these surfaces generally lead to defects in the surface of the strip. This is another reason for frequent shutdowns of the plant.

To avoid the problems related to the rollers running in the liquid coating metal, there have been approaches that involve the use of a coating tank that is open at the bottom and has a guide channel of well-defined height in its lower region for guiding the strip vertically upward through the tank and the use of an electromagnetic seal to seal the opening. This involves the use of electromagnetic inductors, which operate with electromagnetic alternating or traveling fields, which force the liquid metal back or have a pumping or constricting effect and seal the coating tank at the bottom.

A solution of this type is described, for example, in EP 0,673,444 B1. The solution described in WO 96/03533 and the solution described in JP 50-86,446 also make use of an electromagnetic seal for sealing the coating tank at the bottom.

DE 195 35 854 A1 and DE 100 14 867 A1 describe special solutions for precise automatic control of the position of the metal strand in the guide channel. According to the concepts disclosed there, the coils for generating the electromagnetic traveling field are supplemented by correction coils, which are connected to an automatic control system and ensure that when the metal strip deviates from its center position, it is brought back into this position.

A method of this general type is also described in EP 0,630,421 B1, which further provides a premelting tank that is associated with the coating tank that holds the coating metal. The premelting tank has a capacity several times greater than the capacity of the coating tank. The coating tank is supplied with coating metal from the premelting tank as coating metal is removed from the coating tank by the coated metal strand.

The electromagnetic seal used in the solutions discussed above for the purpose of sealing the guide channel constitutes in this respect a magnetic pump that keeps the coating metal in the coating tank.

Industrial trials of installations of this type have shown that the flow pattern on the surface of the metal bath, i.e., the bath surface, is relatively turbulent, which can be attributed to the electromagnetic forces produced by the magnetic seal. The turbulence in the bath has a negative effect on the quality of the hot dip coating.

Therefore, the objective of the invention is to develop a method and a corresponding device for hot dip coating a metal strand, which make it possible to overcome this disadvantage. In other words, the goal is to ensure that the hot dip coating bath will remain undisturbed during the use of an electromagnetic seal and thus that the quality of the coating will be improved.

With respect to the method, the solution to this problem in accordance with the invention is characterized by the fact that a predetermined volume flow of coating metal is supplied to the guide channel in the region of its vertical extent.

As a result of this measure, the seal for sealing the guide channel, which constitutes an electromagnetic pump, no longer operates in a quasi-no-load mode but rather is supplied with and further conveys a volume flow of coating metal. The surprising result is that the surface of the metal bath is quieted, which has a very positive effect on the quality of the hot dip coating.

Provision is generally made for the tank that contains the coating metal to be connected with a supply system (supply tank) for coating metal. The supply tank resupplies the coating tank with the amount of coating metal that is necessary to maintain a constant level in the coating tank, since the metal strand removes coating metal from the coating tank as it passes through the coating installation.

Therefore, in accordance with a first refinement of the invention, it is provided that the predetermined volume flow of coating metal supplied to the guide channel represents a portion of the replenishment volume of coating metal per unit time that is necessary to maintain a desired level of coating metal in the coating tank. Alternatively, it can also be provided that the predetermined volume flow represents the entire replenishment volume of coating metal per unit time that is necessary to maintain this level.

It is advantageous to supply the volume flow of coating metal to the guide channel under open-loop or closed-loop control.

The device for hot dip coating a metal strand, in which the metal strand is passed vertically through the coating tank that holds the molten coating metal and through the upstream guide channel, has at least two inductors installed on either side of the metal strand in the area of the guide channel for generating an electromagnetic field for retaining the coating metal in the coating tank.

In accordance with the invention, the device is characterized by at least one supply line for supplying a predetermined volume flow of coating metal. The supply line opens into the guide channel in the region of the vertical extent of the guide channel.

In this regard, the supply line can open into the region of the long side of the guide channel. It can also open into the region of the short side of the guide channel.

The width or the diameter of the supply line is preferably small relative to the dimension of the long side of the guide channel; this should be understood to mean especially that the width or the diameter of the supply line is no more than 10% of the width of the long side of the guide channel.

Finally, in a preferred modification, the coating tank is connected to a coating metal supply system, from which coating metal is conveyed into the supply line or supply lines.

A specific embodiment of the invention is illustrated in the drawings.

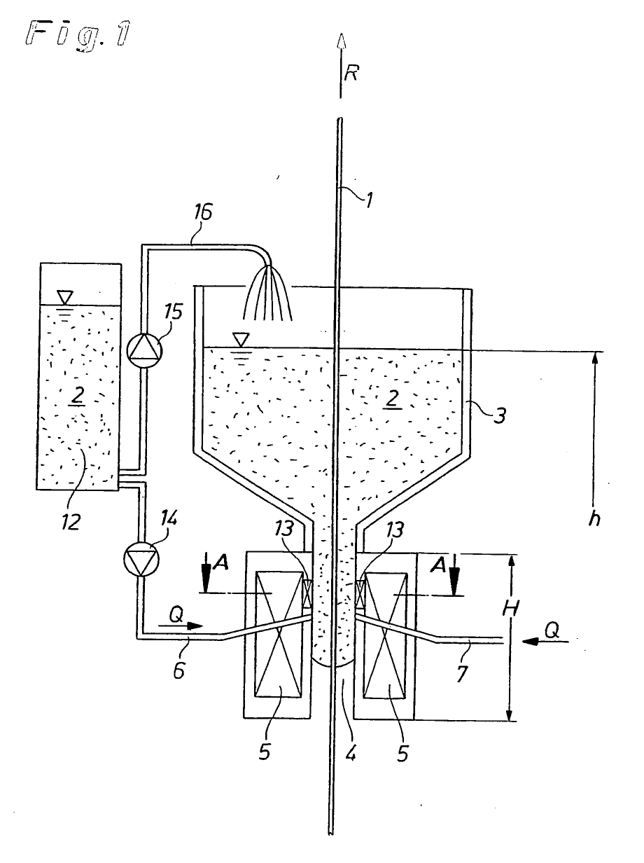

FIG. 1 shows a schematic representation of a hot dip coating device with a metal strand being passed through it.

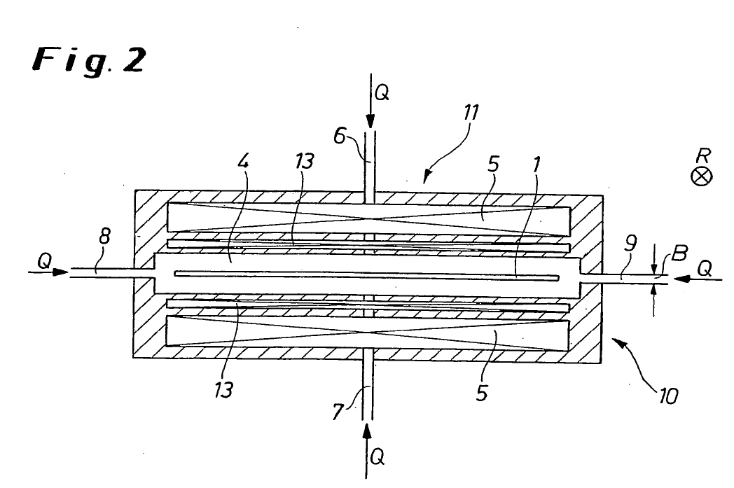

FIG. 2 shows section A-A according to FIG. 1.

The device shown in the drawings has a coating tank 3, which is filled with molten coating metal 2. The coating metal 2 can be, for example, zinc, or aluminum. The metal strand 1 to be coated, which is in the form of a steel strip, passes vertically upward through the coating tank 3 in direction of conveyance R. It should be noted at this point that it is also possible in principle for the metal strand 1 to be passed through the coating tank 3 from top to bottom.

To allow the metal strand 1 to pass through he coating tank 3, the bottom of the tank is open; a guide channel 4 is located in this area and is shown exaggeratedly large and wide. The guide channel 4 has a predetermined height H.

To prevent the molten coating metal 2 from flowing out at the bottom of the guide channel 4, two electromagnetic inductors 5 are installed on either side of the metal strand 1. They generate an electromagnetic field that counteracts the weight of the coating metal 2 and thus seals the guide channel 4 at the bottom.

The inductors 5 are two alternating-field or traveling-field inductors installed opposite each other. They are operated in a frequency range of 2 Hz to 10 kHz and create an electromagnetic transverse field perpendicular to the conveying direction R. The preferred frequency range for single-phase systems (alternating-field inductors) is 2 kHz to 10 kHz, and the preferred frequency range for polyphase systems (e.g., traveling-field inductors) is 2 Hz to 2 kHz.

In addition, to stabilize the metal strand 1 in the center plane of the guide channel 4, correction coils 13 are installed on both sides of the guide channel 4 or metal strand 1. These correction coils 13 are controlled by automatic control devices (not shown) in such a way that the superposition of the magnetic fields of the inductors 5 and of the correction coils 13 always keeps the metal strand 1 centered in the guide channel 4.

Depending on their degree of activation, the correction coils 13 can strengthen or weaken the magnetic field of the inductors 5 (superposition principle). In this way, the position of the metal strand 1 in the guide channel 4 can be influenced.

As the metal strand 1 moves through the coating installation, coating metal 2 is removed from the coating tank 3 due to the adherence of coating metal 2 to the metal strand 1. Therefore, to maintain a desired level h of coating metal 2 in the coating tank 3, it is necessary to replenish the coating metal 2 in the coating tank 3.

In the specific embodiment illustrated here, this is accomplished by a supply system 12 (supply tank), from which a supply line 16 is supplied by a pump 15.

To quiet the bath surface in the coating tank 3, a predetermined volume flow Q of coating metal 2 is supplied to the guide channel 4 in the region of its vertical extent H. For this purpose, as FIG. 1 shows, two supply lines 6 and 7 lead into the region of the passage gap in the guide channel 4 necessary for the passage of the metal strand 1, specifically, in the region of its vertical extent H.

In this regard, as FIG. 2 shows, a total of four supply lines 6, 7, 8, and 9 lead into the passage gap in the guide channel 4. Two of these supply lines, namely, the supply lines 6 and 7, open into the long side 11 of the guide channel 4, and the other two supply lines, namely, supply lines 8 and 9, open into the short side 10 of the guide channel 4.

As the drawing also shows, the width B of the supply lines, namely, in the region of their entrance into the guide channel 4, is small relative to the width of the long side 11 of the guide channel 4.

The supply lines 6, 7, 8, and 9 are supplied with coating metal 2 by a pump 14, which is shown schematically in FIG. 1. As mentioned earlier, the volume flow Q supplied by the pump 14 can constitute a portion of the volume flow of coating metal that must be supplied to the bath to maintain the level h. However, it is also possible for the entire amount of coating metal 2 required for this purpose per unit time to be supplied by the pump 14, so that in this case pump 15 no longer pumps any coating metal.

During the startup of the coating installation, the coating tank 3 is first filled with coating metal 2, the inductors 5 are activated, and then the conveyance of the strip is started. During steady-state operation of the installation, a volume flow Q of coating metal is then supplied to the guide channel 4 through the supply lines 6, 7, 8, and 9, as explained above.

Another very advantageous mode of operation of the illustrated device and method for operating the installation concerns the mode of operating during the turning off and shutdown of the installation:

In the previously customary operation, a residual amount of coating metal 2 always remains in the guide channel 4 and can no longer be conveyed out of the guide channel even by the metal strand 1. The residual amount of molten metal must be collected below the guide channel by a collection system after the inductors 5 have been shut off. This involves a considerable amount of work.

The proposed solution in accordance with the opens up the following possibility:

The inductors 5 are systematically run at full sealing capacity, and no additional coating metal is resupplied through the supply lines 6, 7, 8, 9 (pump 14 shut off). The supply lines 6, 7, 8, 9 then run empty and are thus available for draining the residual coating metal in the guide channel 4.

If correction coils 13 are also present in the guide channel 4 at the level of the supply lines 6, 7, 8, 9 (as explained above), they are also run up to full power for this draining operation. The additional correction coils 13 then produce additional strengthening of the field in the middle of the guide channel 4, and its “potential hill” causes the residual amount of coating metal 2 to escape laterally into the supply lines 6, 7, 8, 9. This helps to convey the residual amount of coating metal 2 out of the guide channel 4.

### LIST OF REFERENCE SYMBOLS

1 metal strand (steel strip)
2 coating metal
3 coating tank
4 guide channel
5 inductor
6 supply line
7 supply line
8 supply line
9 supply line
10 short side of the guide channel
11 long side of the guide channel
12 supply system
13 correction coil
14 pump
15 pump
16 supply line
H height of the guide channel
Q volume flow
h level of molten metal
B width of the supply line
R direction of conveyance

1. Method for hot dip coating a metal strand (1), especially steel strip, in which the metal strand (1) is passed vertically through a coating tank (3) that holds the molten coating metal (2) and through an upstream guide channel (4) of well-defined defined height (H), wherein an electromagnetic field is generated in the region of the guide channel (4) by means of at least two inductors (5) installed on either side of the metal strand (1) for the purpose of retaining the coating metal (2) in the coating tank (3), and wherein a predetermined volume flow (Q) of coating metal is supplied to the guide channel (4) in the region of its vertical extent (H), wherein the predetermined volume flow (Q) of coating metal (2) supplied to the guide channel (4) represents a portion of the replenishment volume of coating metal (2) or the entire replenishment volume of coating metal (2) per unit time that is necessary to maintain a desired level (h) of coating metal (2) in the coating tank (3).

2. Method in accordance with claim 1, wherein the volume flow (Q) of coating metal (2) that is supplied to the guide channel (4) is supplied under open-loop or closed-loop control.

3. Device for hot dip coating a metal strand (1), especially steel strip, in which the metal strand (1) is passed vertically through a coating tank (3) that holds the molten coating metal (2) and through an upstream guide channel (4), with at least two inductors (5) installed on either side of the metal strand (1) in the area of the guide channel (4) for generating an electromagnetic field for retaining the coating metal (2) in the coating tank (3), wherein at least one supply line (6, 7, 8, 9) for supplying a predetermined volume flow (Q) of coating metal (2) opens into the guide channel (4) in the region of the vertical extent (H) of the guide channel (4), for carrying out the method in accordance with claim 1, wherein the supply line (6, 7, 8, 9) opens into the region of the long side (11) and into the region of the short side (10) of the guide channel (4).

4. Device in accordance with claim 3, wherein the width (B) or the diameter of the supply line (6, 7, 8, 9) is small relative to the dimension of the long side (11) of the guide channel (4).

5. Device in accordance with claim 4, wherein the width (B) or the diameter the supply line (6, 7, 8, 9) is no more than 10% of the width of the long side (11) of the guide channel (4).

6. Device in accordance with claim 3, wherein the coating tank (3) is connected to a supply system (12) for coating metal (2), from which coating metal (2) is conveyed into the supply line or supply lines (6, 7, 8, 9).
